(19) United States
(12) Patent Application Publication
(10) Pub. No.: US 2014/0201233 A1
(43) Pub. Date: Jul. 17, 2014

(54) METHOD, DEVICE, AND SYSTEM FOR UPLOADING DATA

(71) Applicant: TENCENT TECHNOLOGY (SHENZHEN) COMPANY LIMITED, Shenzhen (CN)

(72) Inventor: FENG PING, Shenzhen (CN)

(73) Assignee: TENCENT TECHNOLOGY (SHENZHEN) COMPANY LIMITED, Shenzhen (CN)

(21) Appl. No.: 14/153,036

(22) Filed: Jan. 12, 2014

Related U.S. Application Data
(63) Continuation of application No. PCT/CN2013/086154, filed on Oct. 29, 2013.

(30) Foreign Application Priority Data
Jan. 15, 2013 (CN) 201310013799.3

(51) Int. Cl. H04L 29/08

(52) U.S. Cl. CPC H04L 67/1097
USPC 707/769; 709/203

(57) ABSTRACT

Methods, devices, and systems for uploading data are provided. A request for uploading data sent from a user terminal can be received by a proxy server. The request for uploading data contains index information of data to be uploaded. The proxy server can determine whether the data to be uploaded are stored on a storage server, according to the index information of the data to be uploaded. When the proxy server determines that the data to be uploaded are stored on the storage server, a feedback message can be sent by the proxy server to the user terminal that the data to be uploaded are stored on the storage server.

### CROSS-REFERENCES TO RELATED APPLICATIONS

This application is a continuation application of PCT Patent Application No. PCT/CN2013/086154, filed on Oct. 29, 2013, which claims priority to Chinese Patent Application No. CN201310013799.3, filed on Jan. 15, 2013, the entire contents of which are incorporated herein by reference.

### FIELD OF THE DISCLOSURE

The present disclosure relates to the field of data processing technology and, more particularly, relates to processing methods, devices, and systems for uploading data.

### BACKGROUND

When using instant messaging software products, such as QT (i.e., QQ talk) voice program, a user can send the images including, e.g., a local screenshot, a customized image, etc., to members in a same messaging room. When sending these images, the user may need to upload the images first from local device to a backstage server, from which the images are then broadcasted to other members.

Currently, an image with same contents may be repeatedly uploaded by multiple users within a period of time. For example, when there are popular images regarding instant hot issues, a large number of users may send the same popular images from respective rooms for others to share on the internet, generating a large amount of repeated uploading. Such large amount of repeated uploading of same data may waste upstream bandwidth of user terminals and may waste storage space of storage servers.

### BRIEF SUMMARY OF THE DISCLOSURE

One aspect or embodiment of the present disclosure includes a processing method for uploading data. A request for uploading data sent from a user terminal can be received by a proxy server. The request for uploading data contains index information of data to be uploaded. The proxy server can determine whether the data to be uploaded are stored on a storage server, according to the index information of the data to be uploaded. A feedback message can be sent by the proxy server to the user terminal that the data to be uploaded are stored on the storage server, when the proxy server determines that the data to be uploaded are stored on the storage server.

Another aspect or embodiment of the present disclosure includes a proxy server for uploading data. The proxy server can include a receiving unit, a determining unit, and a sending unit. The receiving unit can be configured to receive a request for uploading data from a user terminal, the request for uploading data containing index information of data to be uploaded. The determining unit can be configured, according to the index information of the data to be uploaded received by the receiving unit, to determine whether the data to be uploaded are stored on a storage server. The sending unit can be configured, when the determining unit determines that the data to be uploaded are stored on the storage server, to send a feedback message to the user terminal that the data to be uploaded are stored on the storage server.

Other aspects or embodiments of the present disclosure can be understood by those skilled in the art in light of the description, the claims, and the drawings of the present disclosure.

### BRIEF DESCRIPTION OF THE DRAWINGS

The following drawings are merely examples for illustrative purposes according to various disclosed embodiments and are not intended to limit the scope of the present disclosure.

FIG. 1 depicts an exemplary processing method for uploading data in accordance with various disclosed embodiments;

FIGS. 2-3 depict exemplary scenarios illustrating processing methods for uploading data in accordance with various disclosed embodiments;

FIG. 4 depicts an exemplary proxy server in accordance with various disclosed embodiments;

FIG. 5 depicts another exemplary proxy server in accordance with various disclosed embodiments;

FIG. 6 depicts another exemplary proxy server in accordance with various disclosed embodiments;

FIG. 7 depicts another exemplary proxy server in accordance with various disclosed embodiments;

FIG. 8 depicts an exemplary system for uploading data in accordance with various disclosed embodiments;

FIG. 9 depicts an exemplary system for uploading data in accordance with various disclosed embodiments;

FIG. 10 depicts an exemplary environment incorporating certain disclosed embodiments; and

FIG. 11 depicts an exemplary server consistent with the disclosed embodiments.

### DETAILED DESCRIPTION

Reference will now be made in detail to exemplary embodiments of the disclosure, which are illustrated in the accompanying drawings. Wherever possible, the same reference numbers will be used throughout the drawings to refer to the same or like parts.

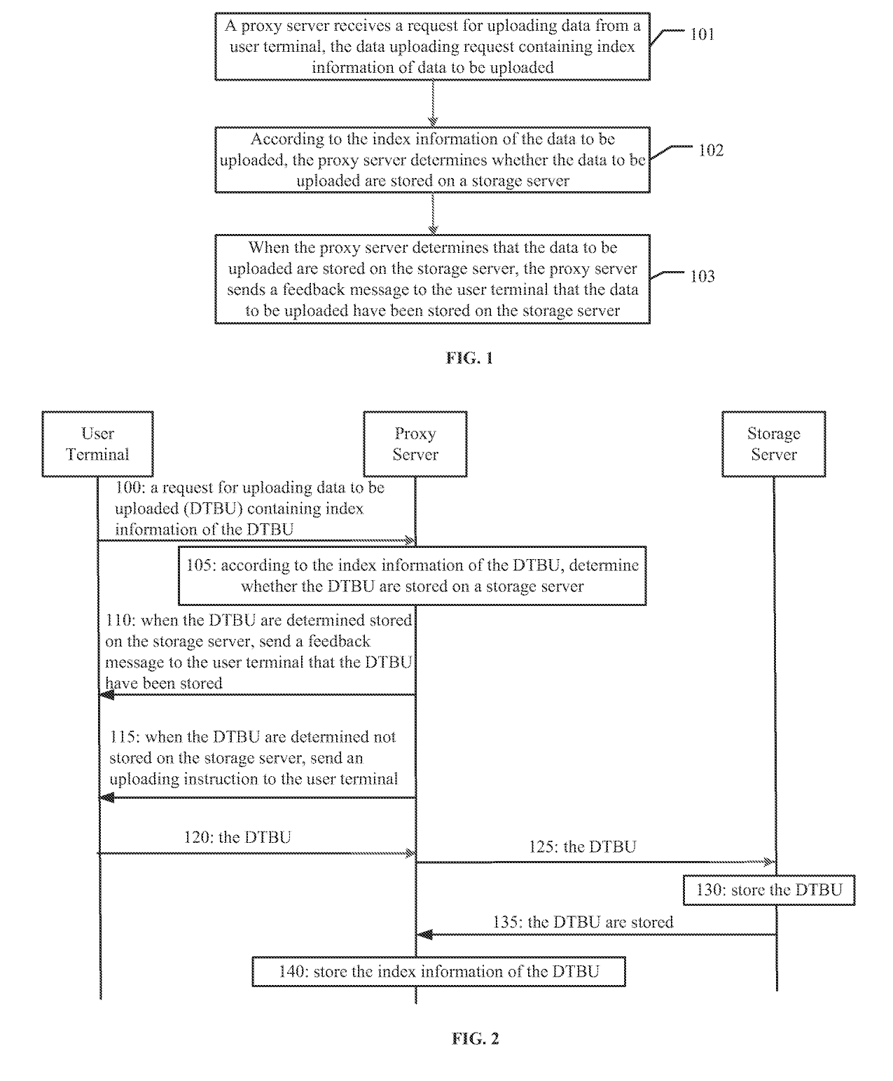

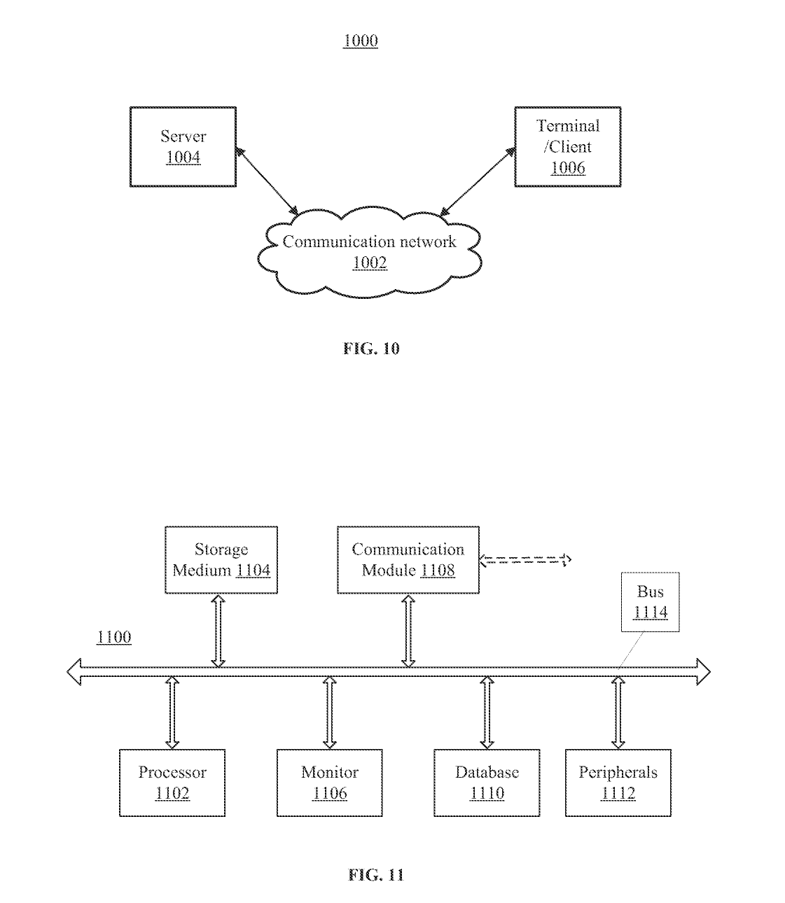

FIGS. 1-9 depict exemplary processing methods, devices (e.g., server devices), and systems for uploading data in accordance with various disclosed embodiments. The disclosed processing methods, devices, and systems for uploading data can avoid repeated uploading of same data. In addition, upstream bandwidth of user terminals and storage space of storage servers can then be saved. The exemplary methods, devices, and systems can be implemented, for example, in an exemplary environment 1000 as shown in FIG. 10.

As shown in FIG. 10, the environment 1000 can include a server 1004, a terminal/client 1006 (hereinafter referred as “terminal 1006”), and a communication network 1002. The server 1004 and the terminal 1006 may be coupled through the communication network 1002 for information exchange, for example, Internet searching, webpage browsing, etc. Although only one terminal 1006 and one server 1004 are shown in the environment 1000, any number of terminals 1006 or servers 1004 may be included, and other devices may also be included.

The communication network 1002 may include any appropriate type of communication network for providing network connections to the server 1004 and terminal 1006 or among multiple servers 1004 or terminals 1006. For example, the communication network 1002 may include the Internet or other types of computer networks or telecommunication networks, either wired or wireless.

A terminal, as used herein, may refer to any appropriate user terminal with certain computing capabilities, for example, a personal computer (PC), a work station computer, a server computer, a hand-held computing device (tablet), a mobile terminal (a mobile phone or a smart phone), or any other user-side computing device.

A server, as used herein, may refer one or more server computers configured to provide certain server functionalities, for example, search engines and database management. A server may also include one or more processors to execute computer programs in parallel. As disclosed herein, the server may include a proxy server, a storage server, and/or an index server.

The server 1004 and the terminal 1006 may be implemented on any appropriate computing platform. FIG. 11 shows a block diagram of an exemplary computer system 1100 capable of implementing the server 1004 and/or the terminal 1006. As shown in FIG. 11, the exemplary computer system 1100 may include a processor 1102, a storage medium 1104, a monitor 1106, a communication module 1108, a database 1110, peripherals 1112, and one or more bus 1114 to couple the devices together. Certain devices may be omitted and other devices may be included.

The processor 1102 can include any appropriate processor or processors. Further, the processor 1102 can include multiple cores for multi-thread or parallel processing. The storage medium 1104 may include memory modules, for example, ROM, RAM, and flash memory modules, and mass storages, for example, CD-ROM, U-disk, removable hard disk, etc. The storage medium 1104 may store computer programs for implementing various processes, when executed by the processor 1102.

Further, the peripherals 1112 may include I/O devices, for example, keyboard and mouse, and the communication module 1108 may include network devices for establishing connections through the communication network 1002. The database 1110 may include one or more databases for storing certain data and for performing certain operations on the stored data, for example, webpage browsing, database searching, etc.

In operation, the terminal 1006 may cause the server 1004 to perform certain actions, for example, an Internet search or other database operations. The server 1004 may be configured to provide structures and functions for such actions and operations. More particularly, the server 1004 may include a data searching system for real-time database searching. In various embodiments, a user terminal, for example, a mobile terminal involved in the disclosed methods and systems can include the terminal 1006.

FIG. 1 depicts an exemplary processing method for uploading data in accordance with various disclosed embodiments. In Step 101, a proxy server receives a request for uploading data (i.e., a data uploading request) from a user terminal. The data uploading request contains index information of data to be uploaded.

In various embodiments, the user terminal can be a PC (i.e., personal computer), a PDA (i.e., personal digital assistant), a notebook computer, a mobile phone, and/or other suitable terminals.

The index information of the data to be uploaded can include an identification of the data to be uploaded. One piece of index information can identify one data piece (or one data item). The index information can include information of the data to be uploaded including, e.g., MD5 (i.e., message-digest algorithm 5). The MD5 can be obtained by calculation of the user terminal.

In Step 102, according to the index information of the data to be uploaded, the proxy server determines whether the data to be uploaded are stored on a storage server. That is, the proxy server determines whether the data to be uploaded have been uploaded previously. When it is determined that the data to be uploaded have been uploaded previously, the method proceed to perform Step 103.

In Step 103, when the proxy server determines that the data to be uploaded are stored on the storage server, the proxy server sends a feedback message to the user terminal to include that the data to be uploaded have been stored on the storage server.

If the proxy server determines that the data to be uploaded have been uploaded, there is no need for the user terminal to repeatedly upload the data to be uploaded. In other words, that the data to be uploaded have been on the storage server can be fed back to the user terminal such that the user terminal does not need to repeatedly upload the data to be uploaded. This saves an upstream bandwidth of the user terminal and thus improves uploading speed of the user terminal. User experience can be improved.

As disclosed, a request for uploading data (i.e., a data uploading request) sent from a user terminal can be received. The data uploading request contains index information of data to be uploaded. According to the index information of the data to be uploaded, it is determined whether the data to be uploaded are stored on the storage server. When it is determined that the data to be uploaded have been uploaded previously, a feedback message can be sent to the user terminal that the data to be uploaded have been on the storage server. In this manner, the disclosed processing method for uploading data can avoid repeated uploading of same data. Upstream bandwidth of the user terminal and storage space of the storage server can then be saved.

Optionally, based on the embodiment depicted in FIG. 1, in various embodiments, the Step to determine whether the data to be uploaded are stored on the storage server according to the index information of the data to be uploaded may include: searching for the index information of the data to be uploaded from the stored index information corresponding to those uploaded data to provide search results; and, according to the search results, determining whether the data to be uploaded have been stored on the storage server.

In an exemplary embodiment, the index information corresponding to the uploaded data is stored on the proxy server. In this case, the proxy server can search the stored index information corresponding to those uploaded data to determine whether there is the index information corresponding to the data to be uploaded within the index information corresponding to those uploaded data.

When the index information corresponding to the data to be uploaded has been stored within the index information corresponding to those uploaded data, it is determined that the data to be uploaded has been stored in the storage server. When the index information corresponding to the data to be uploaded has not been found within the index information corresponding to those uploaded data, it is determined that the data to be uploaded has been stored in the storage server.

Optionally, based on the embodiment depicted in FIG. 1, in various embodiments, the Step to determine whether the data to be uploaded are stored on the storage server according to the index information of the data to be uploaded may include: sending a request for searching index information (i.e., an index-information searching request) to an index server, the index-information searching request containing the index information of the data to be uploaded such that the index server can search for the index information of the data to be uploaded and provide search results; receiving the search results from the index server; and according to the search results, determining whether the data to be uploaded have been stored on the storage server.

As disclosed herein, the index information corresponding to the uploaded data is stored on the proxy server. The proxy server may send a request for searching index information (i.e., index-information searching request) to an index server such that, according to the index information of the data to be uploaded, the index server can search for the index information of the data to be uploaded from the index information of those uploaded data and return search results to the proxy server.

When the search results returned from the index server and received by the proxy server include that the index information of the data to be uploaded is founded, it determined that the data to be uploaded have been stored on the storage server. When the search results returned from the index server and received by the proxy server include that the index information of the data to be uploaded is not founded, the proxy server can determine that the data to be uploaded have not been stored on the storage server.

Optionally, based on the embodiment depicted in FIG. 1, in various embodiments, after the Step to determine whether the data to be uploaded are stored on the storage server, the method may further include: sending an uploading instruction to the user terminal by the proxy server when it is determined that the data to be uploaded are not stored on the storage server; receiving the data to be uploaded from the user terminal, sending the data to be uploaded to the storage server for the storage server to store the data to be uploaded; and storing the index information of the data to be uploaded.

Disclosed herein includes use of the proxy server to store index information of data to be uploaded. When the proxy server determines that the data to be uploaded are not stored on the storage server, the proxy server sends an uploading instruction to the user terminal for the user terminal to upload the data to be uploaded and to send the data to be uploaded to the storage sever. The storage sever can then store the data to be uploaded. Meanwhile, after the data to be uploaded are stored on the storage sever, the proxy server can store the index information of the data to be uploaded. In this case, when there are subsequent data, same as the data to be uploaded, needed to be uploaded, it can be determined whether the subsequent data to be uploaded have been stored on the storage server.

Optionally, based on the embodiment depicted in FIG. 1, in various embodiments, after the Step to determine whether the data to be uploaded are stored on the storage server, the method may further include: sending an uploading instruction to the user terminal by the proxy server when it is determined that the data to be uploaded are not stored on the storage server; receiving the data to be uploaded from the user terminal, sending the data to be uploaded to the storage server for the storage server to store the data to be uploaded; and sending to the index server a storing instruction for storing the index information of the data to be uploaded for the index server to store the index information of the data to be uploaded.

Disclosed herein includes use of the index server to store index information of data to be uploaded. When the proxy server determines that the data to be uploaded are not stored on the storage server, the proxy server sends an uploading instruction to the user terminal for the user terminal to upload the data to be uploaded and to send the data to be uploaded to the storage sever. The storage sever can then store the data to be uploaded. Meanwhile, after the data to be uploaded are stored on the storage sever, the proxy server can send a storing instruction for storing the index information of the data to be uploaded to the index server for the index server to store the index information of the data to be uploaded. In this case, when there are subsequent data, same as the data to be uploaded, needed to be uploaded, it can be determined whether the subsequent data to be uploaded have been stored on the storage server.

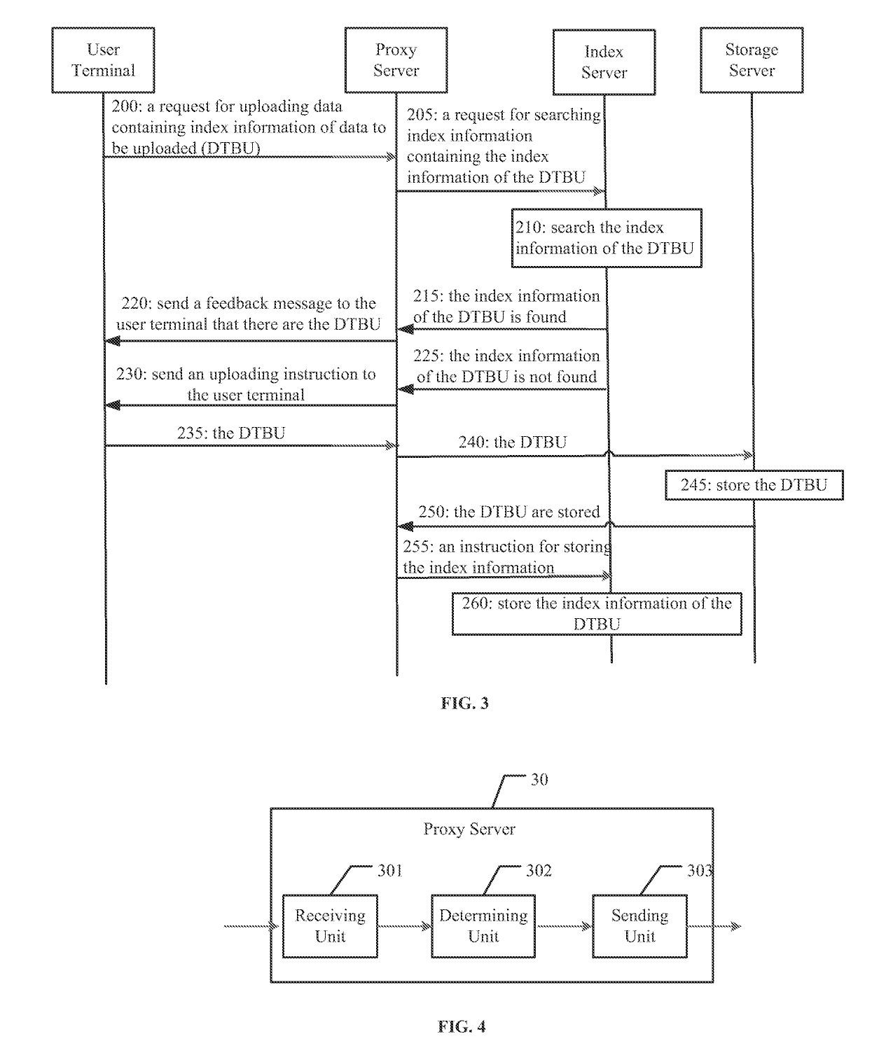

For illustration purposes, FIGS. 2-3 depict exemplary scenarios illustrating processing methods for uploading data in accordance with various disclosed embodiments.

Referring to FIG. 2, in Step 100, a proxy server receives a request for uploading data (i.e., a data uploading request) from a user terminal. The data uploading request contains index information of data to be uploaded.

In Step 105, according to the index information of the data to be uploaded, the proxy server determines whether the data to be uploaded are stored on a storage server.

To determine whether the data to be uploaded are stored on the storage server, the proxy server can search for the index information corresponding to the data to be uploaded from the stored index information corresponding to those uploaded data. When the index information corresponding to the data to be uploaded is found within the index information corresponding to those uploaded data, the method proceeds to perform Step 110. When the index information corresponding to the data to be uploaded is not found within the index information corresponding to those uploaded data, the method proceeds to perform Step 115.

In Step 110, when the proxy server determines that the data to be uploaded are stored on the storage server, the proxy server sends a feedback message to the user terminal to include that the data to be uploaded have been on the storage server.

In Step 115, when the proxy server determines that the data to be uploaded are not stored on the storage server, the proxy server sends an uploading instruction to the user terminal. In Step 120, the proxy server receives the data to be uploaded that are uploaded by the user terminal. In Step 125, the proxy server sends the data to be uploaded to the storage server.

In Step 130, the storage server stores the data to be uploaded. In Step 135, the storage server sends a feedback message to the proxy server that the data to be uploaded have been stored. In Step 140, the proxy server stores the index information of the data to be uploaded, such that, when there are subsequent data, same as the data to be uploaded, needed to be uploaded, it can be determined whether the subsequent data to be uploaded have been stored on the storage server.

Referring to FIG. 3, in Step 200, a proxy server receives a request for uploading data (i.e., a data uploading request) from a user terminal. The data uploading request contains index information of data to be uploaded.

In Step 205, the proxy server sends a request for searching index information (i.e., index-information searching request) to an index server, the index-information searching request containing the index information of the data to be uploaded.

In Step 210, the index server searches the index information of the data to be uploaded. In Step 215, the proxy server receives a message sent from the index server that there is the index information of the data to be uploaded. In Step 220, the proxy server sends a feedback message to the user terminal that there are the data to be uploaded.

In Step 225, the proxy server receives a message sent from the index server that the index information of the data to be uploaded has not been found. In Step 230, the proxy server sends an uploading instruction to the user terminal. In Step 235, the proxy server receives the data to be uploaded from the user terminal. In Step 240, the proxy server sends the data to be uploaded to the storage server.

In Step 245, the storage server stores the data to be uploaded. In Step 250, the storage server sends a feedback message to the proxy server that the data to be uploaded have been stored. In Step 255, the proxy server sends an instruction for storing the index information of the data to be uploaded to the index server.

In Step 260, the index server stores the index information of the data to be uploaded. In this manner, FIGS. 2-3 depict different exemplary scenarios for uploading data without repeated uploading of same data. In addition, upstream bandwidth of the user terminal and storage space of the storage server can be saved.

FIG. 4 depicts an exemplary proxy server in accordance with various disclosed embodiments. The exemplary proxy server includes a receiving unit 301, a determining unit 302, and/or a sending unit 303.

The receiving unit 301 is configured to receive a request for uploading data (i.e., a data uploading request) from a user terminal. The data uploading request contains index information of data to be uploaded.

The determining unit 302 is configured, according to the index information of the data to be uploaded received by the receiving unit 301, to determine whether the data to be uploaded are stored on a storage server.

The sending unit 303 is configured, when the determining unit 302 determines that the data to be uploaded are stored on the storage server, to send a feedback message to the user terminal to include that the data to be uploaded have been stored on the storage server.

As disclosed, the receiving unit 301 receives a request for uploading data (i.e., a data uploading request) sent from a user terminal. The data uploading request contains index information of data to be uploaded. According to the index information of the data to be uploaded received by the receiving unit 301, the determining unit 302 determines whether the data to be uploaded are stored on the storage server. When the determining unit 302 determines that the data to be uploaded have been uploaded previously, the sending unit 303 sends a feedback message to the user terminal to include that the data to be uploaded have been on the storage server. In this manner, the disclosed exemplary proxy server can avoid repeated uploading of same data. Upstream bandwidth of the user terminal and storage space of the storage server can then be saved.

Based on the embodiment depicted in FIG. 4, referring to another exemplary embodiment depicted FIG. 5, the determining unit 302 can include a searching sub-unit 3021 and/or a first determining sub-unit 3022.

The searching sub-unit 3021 is configured to search for the index information of the data to be uploaded from the stored index information corresponding to those uploaded data.

The first determining sub-unit 3022 is configured to determine whether the data to be uploaded have been stored on the storage server, according to the search results from the searching sub-unit 3021.

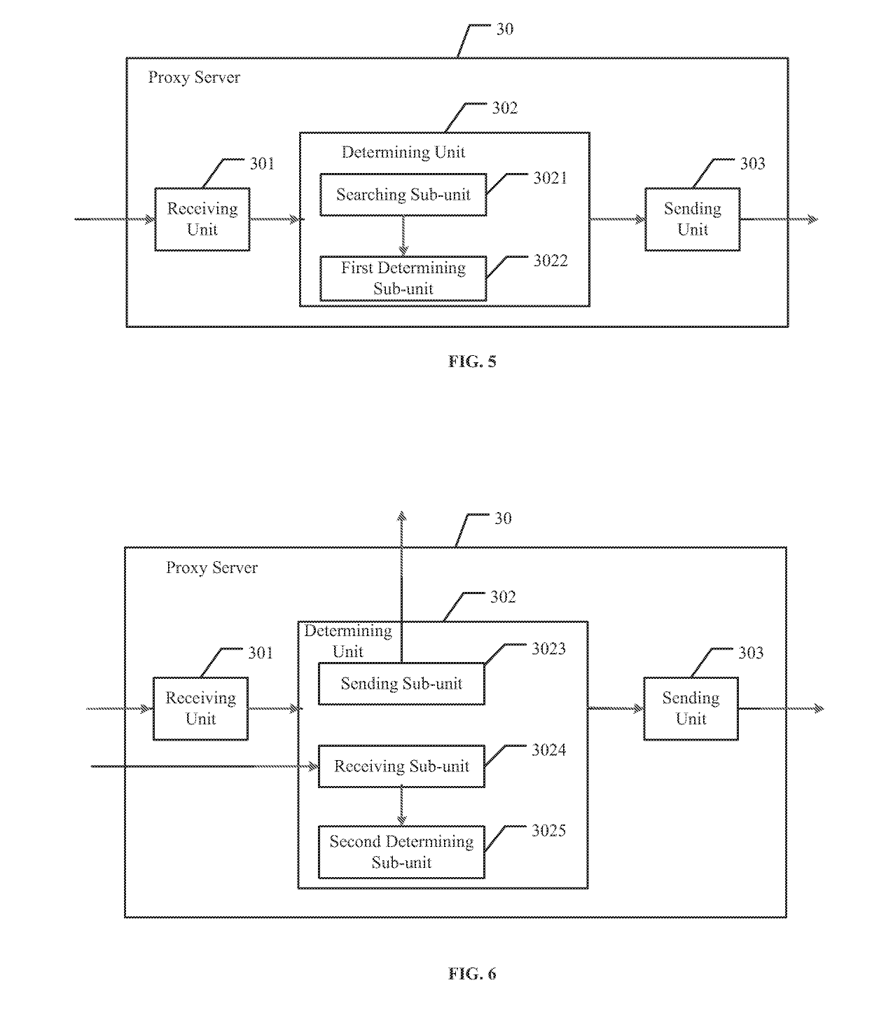

Based on the embodiment depicted in FIG. 4, referring to another exemplary embodiment depicted FIG. 6, the determining unit 302 includes a sending sub-unit 3023, a receiving sub-unit 3024, and/or a second determining sub-unit 3025.

The sending sub-unit 3023 is configured to send a request for searching index information (i.e., index-information searching request) to an index server, the index-information searching request containing the index information of the data to be uploaded such that the index server can search for the index information of the data to be uploaded.

The receiving sub-unit 3024 is configured to receive search results from the index server. The second determining sub-unit 3025 is configured, according to the search results received from the receiving sub-unit 3024, to determine whether the data to be uploaded have been stored on the storage server.

Based on the embodiment depicted in FIG. 4, FIG. 7 depicted another exemplary proxy server in accordance with various disclosed embodiments. In FIG. 7, the sending unit 303 is configured to send an uploading instruction to the user terminal, when the determining unit 302 determines that the data to be uploaded are not stored on the storage server.

The receiving unit 301 is further configured to receive the data to be uploaded from the user terminal. The sending unit 302 is further configured to send the data to be uploaded to the storage server for the storage server to store the data to be uploaded. A storing unit 304 is configured to store the index information of the data to be uploaded, after the sending unit 302 sends the data to be uploaded.

Based on the embodiment depicted in FIG. 4, in another exemplary proxy server, the sending unit 303 is configured to send an uploading instruction to the user terminal, after the determining unit 302 determines that the data to be uploaded are not stored on the storage server.

The receiving unit 301 is configured to receive the data to be uploaded from the user terminal. The sending unit 303 is configured to send the data to be uploaded to the storage server for the storage server to store the data to be uploaded, and to send a storing instruction for storing the index information of the data to be uploaded to the index server for the index server to store the index information of the data to be uploaded.

FIG. 8 depicts an exemplary system for uploading data in accordance with various disclosed embodiments. The exemplary system can include a user terminal 20, a proxy server 30, and/or a storage server 40.

The user terminal 20 is configured to send a request for uploading data (i.e., a data uploading request). The data uploading request contains index information of data to be uploaded.

The proxy server 30 is configured to receive a request for uploading data (i.e., a data uploading request) from a user terminal. The data uploading request contains index information of data to be uploaded. According to the index information of the data to be uploaded, the proxy server 30 determines whether the data to be uploaded are stored on the storage server. When the proxy server 30 determines that the data to be uploaded are stored on the storage server 40, the proxy server 30 sends a feedback message to the user terminal 20 to include that the data to be uploaded have been on the storage server.

The storage server 40 is configured to store the uploaded data.

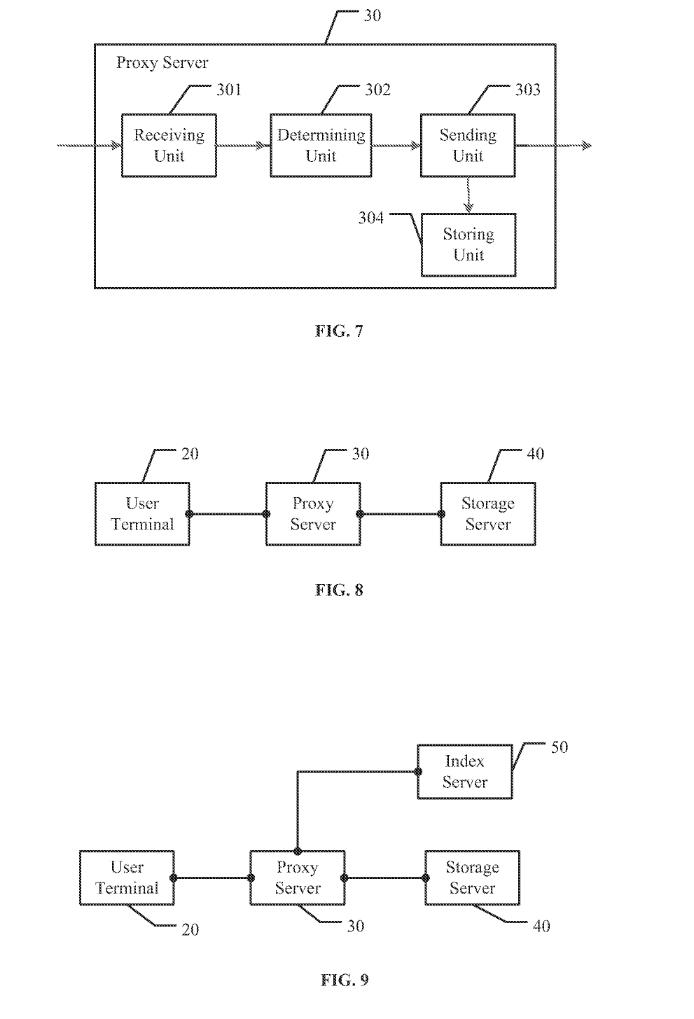

FIG. 9 depicts another exemplary system for uploading data in accordance with various disclosed embodiments. The exemplary system can include a user terminal 20, a proxy server 30, a storage server 40, and/or an index server 50.

The user terminal 20 is configured to send a request for uploading data (i.e., a data uploading request). The data uploading request contains index information of data to be uploaded.

The proxy server 30 is configured to receive a request for uploading data (i.e., a data uploading request) from a user terminal. The data uploading request contains index information of data to be uploaded. According to the index information of the data to be uploaded, the proxy server 30 determines whether the data to be uploaded are stored on the storage server. When the proxy server 30 determines that the data to be uploaded are stored on the storage server 40, the proxy server 30 sends a feedback message to the user terminal 20 to include that the data to be uploaded have been on the storage server.

The storage server 40 is configured to store uploaded data. The index server 50 is configured to store index information corresponding to the uploaded data.

In this manner, the disclosed exemplary system for uploading data can avoid repeated uploading of same data. In addition, upstream bandwidth of the user terminal and storage space of the storage server can be saved.

It should be noted that, in the present disclosure each embodiment is progressively described, e.g., each embodiment is described and focused on differences between embodiments. Similar and/or the same portions between various embodiments can be referred to one another. In addition, exemplary device/server/system are described with respect to corresponding methods.

Note that, the term “comprising”, “including” or any other variants thereof are intended to cover a non-exclusive inclusion, such that the process, method, article, system, or apparatus containing a number of elements also include not only those elements, but also other elements that are not expressly listed; or further include inherent elements of the process, method, article or apparatus. Without further restrictions, the statement “includes a . . . ” does not exclude other elements included in the process, method, article, system, or apparatus having those elements.

A person of ordinary skill in the art can understand that the units included herein are described according to their functional logic, but are not limited to the above descriptions as long as the units can implement corresponding functions. Further, the specific name of each functional unit is used for distinguishing from on another without limiting the protection scope of the present disclosure.

In various embodiments, the disclosed units can be configured in one apparatus or configured in multiple apparatus as desired. The units disclosed herein can be integrated in one unit or in multiple units. Each of the units disclosed herein can be divided into one or more sub-units, which can be recombined in any manner.

One of ordinary skill in the art would appreciate that suitable software and/or hardware (e.g., a universal hardware platform) may be included and used in the disclosed methods and systems. For example, the disclosed embodiments can be implemented by hardware only, which alternatively can be implemented by software products only. The software products can be stored in a computer-readable storage medium including, e.g., ROM/RAM, magnetic disk, optical disk, etc. The software products can include suitable commands to enable a terminal device (e.g., including a mobile phone, a personal computer, a server, or a network device, etc.) to implement the disclosed embodiments.

The embodiments disclosed herein are exemplary only. Other applications, advantages, alternations, modifications, or equivalents to the disclosed embodiments are obvious to those skilled in the art and are intended to be encompassed within the scope of the present disclosure.

### INDUSTRIAL APPLICABILITY AND ADVANTAGEOUS EFFECTS

Without limiting the scope of any claim and/or the specification, examples of industrial applicability and certain advantageous effects of the disclosed embodiments are listed for illustrative purposes. Various alternations, modifications, or equivalents to the technical solutions of the disclosed embodiments can be obvious to those skilled in the art and can be included in this disclosure.

Processing methods, devices (e.g., server devices), and systems for uploading data are provided herein. A request for uploading data sent from a user terminal can be received by a proxy server. The request for uploading data contains index information of data to be uploaded. The proxy server can determine whether the data to be uploaded are stored on a storage server, according to the index information of the data to be uploaded. A feedback message can be sent by the proxy server to the user terminal that the data to be uploaded are stored on the storage server, when the proxy server determines that the data to be uploaded are stored on the storage server. The disclosed processing methods, devices, and systems for uploading data can avoid repeated uploading of same data. In addition, upstream bandwidth of user terminals and storage space of storage servers can be saved.

What is claimed is:

1. A processing method for uploading data, comprising:
receiving, by a proxy server, a request for uploading data sent from a user terminal, wherein the request for uploading data comprises index information of data to be uploaded;
determining, by the proxy server, whether the data to be uploaded are stored on a storage server, according to the index information of the data to be uploaded; and
sending, by the proxy server, a feedback message to the user terminal that the data to be uploaded are stored on the storage server, when the proxy server determines that the data to be uploaded are stored on the storage server.

2. The method of claim 1, wherein determining whether the data to be uploaded are stored on the storage server according to the index information of the data to be uploaded comprises:
searching for the index information of the data to be uploaded from stored index information corresponding to uploaded data and providing search results; and
according to the search results, determining whether the data to be uploaded have been stored on the storage server.

3. The method of claim 1, wherein determining whether the data to be uploaded are stored on the storage server according to the index information of the data to be uploaded comprises:
sending a request for searching index information to an index server, wherein the request for searching index information comprises the index information of the data to be uploaded for the index server to search for the index information of the data to be uploaded and to provide search results;
receiving the search results from the index server; and
according to the search results, determining whether the data to be uploaded have been stored on the storage server.

4. The method of claim 1, wherein, after determining whether the data to be uploaded are stored on the storage server, the method further comprises:
sending an uploading instruction to the user terminal, when the data to be uploaded are determined not stored on the storage server;
receiving the data to be uploaded from the user terminal;
sending the data to be uploaded to the storage server for the storage server to store the data to be uploaded; and
storing the index information of the data to be uploaded.

5. The method of claim 2, wherein, after determining whether the data to be uploaded are stored on the storage server, the method further comprises:
sending an uploading instruction to the user terminal, when the data to be uploaded are determined not stored on the storage server;
receiving the data to be uploaded from the user terminal;
sending the data to be uploaded to the storage server for the storage server to store the data to be uploaded; and
storing the index information of the data to be uploaded.

6. The method of claim 1, wherein, after determining whether the data to be uploaded are stored on the storage server, the method further comprises:
sending an uploading instruction to the user terminal, when the data to be uploaded are determined not stored on the storage server;
receiving the data to be uploaded from the user terminal;
sending the data to be uploaded to the storage server for the storage server to store the data to be uploaded; and
sending to an index server a storing instruction for storing the index information of the data to be uploaded for the index server to store the index information of the data to be uploaded.

7. The method of claim 3, wherein, after determining whether the data to be uploaded are stored on the storage server, the method further comprises:
sending an uploading instruction to the user terminal, when the data to be uploaded are determined not stored on the storage server;
receiving the data to be uploaded from the user terminal;
sending the data to be uploaded to the storage server for the storage server to store the data to be uploaded; and
sending to the index server a storing instruction for storing the index information of the data to be uploaded for the index server to store the index information of the data to be uploaded.

8. A proxy server for uploading data, comprising:
a receiving unit configured to receive a request for uploading data from a user terminal, the request for uploading data comprising index information of data to be uploaded;
a determining unit configured, according to the index information of the data to be uploaded received by the receiving unit, to determine whether the data to be uploaded are stored on a storage server; and
a sending unit configured, when the determining unit determines that the data to be uploaded are stored on the storage server, to send a feedback message to the user terminal that the data to be uploaded are stored on the storage server.

9. The server of claim 8, wherein the determining unit comprises:
a searching sub-unit configured to search for the index information of the data to be uploaded from stored index information corresponding to uploaded data and to provide search results; and
a first determining sub-unit configured to determine whether the data to be uploaded have been stored on the storage server, according to the search results from the searching sub-unit.

10. The server of claim 8, wherein the determining unit comprises:
a sending sub-unit configured to send a request for searching index information to an index server, wherein the request for searching index information comprises the index information of the data to be uploaded for the index server to search for the index information of the data to be uploaded;
a receiving sub-unit configured to receive search results from the index server; and
a second determining sub-unit configured, according to the search results received from the receiving sub-unit, to determine whether the data to be uploaded have been stored on the storage server.

11. The server of claim 8, further comprising a storing unit, wherein:
the sending unit is further configured to send an uploading instruction to the user terminal, when the determining unit determines that the data to be uploaded are not stored on the storage server;
the receiving unit is further configured to receive the data to be uploaded from the user terminal, wherein the sending unit is further configured to send the data to be uploaded to the storage server for the storage server to store the data to be uploaded; and
the storing unit is configured to store the index information of the data to be uploaded, after the sending unit sends the data to be uploaded.

12. The server of claim 9, further comprising a storing unit, wherein:
the sending unit is further configured to send an uploading instruction to the user terminal, when the determining unit determines that the data to be uploaded are not stored on the storage server;
the receiving unit is further configured to receive the data to be uploaded from the user terminal, wherein the sending unit is further configured to send the data to be uploaded to the storage server for the storage server to store the data to be uploaded; and
the storing unit is configured to store the index information of the data to be uploaded, after the sending unit sends the data to be uploaded.

13. The server of claim 8, wherein:
the sending unit is configured to send an uploading instruction to the user terminal, after the determining unit determines that the data to be uploaded are not stored on the storage server;
the receiving unit is configured to receive the data to be uploaded from the user terminal; and
the sending unit is configured to send the data to be uploaded to the storage server for the storage server to store the data to be uploaded, and to send a storing instruction for storing the index information of the data to be uploaded to an index server for the index server to store the index information of the data to be uploaded.

14. The server of claim 10, wherein:
the sending unit is configured to send an uploading instruction to the user terminal, after the determining unit determines that the data to be uploaded are not stored on the storage server;
the receiving unit is configured to receive the data to be uploaded from the user terminal; and
the sending unit is configured to send the data to be uploaded to the storage server for the storage server to store the data to be uploaded, and to send a storing instruction for storing the index information of the data to be uploaded to the index server for the index server to store the index information of the data to be uploaded.

15. A processing system for uploading data; comprising:
a storage server; and
a proxy server, wherein the proxy server comprises:
a receiving unit configured to receive a request for uploading data from a user terminal, the request for uploading data comprising index information of data to be uploaded;
a determining unit configured, according to the index information of the data to be uploaded received by the receiving unit, to determine whether the data to be uploaded are stored on a storage server; and
a sending unit configured, when the determining unit determines that the data to be uploaded are stored on the storage server, to send a feedback message to the user terminal that the data to be uploaded are stored on the storage server.

16. The processing system of claim 15, wherein the determining unit comprises:
a searching sub-unit configured to search for the index information of the data to be uploaded from stored index information corresponding to uploaded data and to provide search results; and
a first determining sub-unit configured to determine whether the data to be uploaded have been stored on the storage server, according to the search results from the searching sub-unit.

17. A processing system of claim 15, further comprising:
an index server.

18. A processing system of claim 15, further comprising:
an index server.
